(19) United States
(12) Patent Application Publication
(10) Pub. No.: US 2023/0254948 A1
(43) Pub. Date: Aug. 10, 2023

(54) EXTREMITY OUTERWEAR INDUCTION HEATING SYSTEM

(71) Applicant: William WILLARD, Saratoga Springs, NY (US)

(72) Inventor: William WILLARD, Saratoga Springs, NY (US)

(21) Appl. No.: 18/164,188

(22) Filed: Feb. 3, 2023

Related U.S. Application Data
(60) Provisional application No. 63/307,019, filed on Feb. 5, 2022.

(51) Int. Cl. H05B 6/10; A41D 19/00; A41D 13/005

(52) U.S. Cl. CPC H05B 6/10; A41D 19/0024; A41D 13/0051

(57) ABSTRACT

An article of clothing operable for induction heating may include a wearable covering positionable on a wearer, the wearable covering comprising conductive material extendable on at least a first side portion wearer and conductive material disposed on a second opposite side portion of the wearer with the portion of the wearer disposed therebetween, and the wearable covering operable to simultaneously warm a first side portion of the wearer and the opposite second side wearer upon positioning the wearable covering in a passageway in an energizable coil. A method may include obtaining a wearable covering having conductive material, inserting the wearable covering into a passageway in an energizable coil, warming the wearable covering in response to induction heating of the wearable covering in the passageway in the energizable coil, and removing the wearable covering from the passageway in the energizable coil.

### CROSS-REFERENCE TO RELATED APPLICATIONS

This application claims priority benefit of U.S. provisional patent application No. 63/307,019, filed Feb. 5, 2022, entitled “Extremity Outerwear Induction Heating System,” which application is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### TECHNICAL FIELD

The present disclosure is directed, in some embodiments, to self-contained or externally powered induction heat systems tailored to outerwear, e.g., gloves, that can be carried by or attached to the user.

### BACKGROUND

Traditionally, in connection with ski gloves, solutions for adding heat for increased long term comfort focus on systems integrated into the ski gloves. These systems are built in or affixed into outerwear and are complicated and expensive. These systems typically use electrical resistance principles to circulate heat within the gloves through an array of wires or other methods built into the design. The power source is either a battery or other rechargeable material.

### SUMMARY

Shortcomings of the prior art are overcome and additional advantages are provided through the provision of a method, which includes for example, obtaining a wearable covering comprising conductive material, inserting the wearable covering into a passageway in an energizable coil, warming the wearable covering in response to induction heating of the wearable covering in the passageway in the energizable coil, and removing the wearable covering from the passageway in the energizable coil.

In some embodiments, the method may include the wearable covering disposable around a first side portion of a wearer with the conductive material disposed on a first side of the wearable covering and over first side portion of the wearer, and the conductive material disposed on an opposite second side of the wearable covering and over a second side portion of the wearer, and the warming comprises simultaneously warming the first side of the wearable covering and the opposite second side of the wearable covering in response to induction heating of the wearable covering in the passageway in the energizable coil.

In another embodiment, a system includes, for example, an induction heating station having a housing having at least one opening having a passageway therethrough aligned with a passageway in an energizable coil, and a wearable covering sized and configured to extend around a portion of a wearer and fit within the at least one opening in the housing, the wearable covering comprising conductive material disposed on a first side of the wearer and conductive material disposed on an opposite second side of the wearer. The wearable covering is positionable in the at least one opening in the housing to simultaneously warm the first side of the wearer and the opposite second side of the wearer based on induction heating of the wearable covering in the passageway in the energizable coil.

In another embodiment, an article of clothing operable for induction heating includes, for example, a wearable covering positionable on a wearer, the wearable covering having conductive material extendable on at least a first side portion of the wearer and conductive material disposed on a second opposite side portion of the wearer with the portion of the wearer disposed therebetween, and the wearable covering being operable to simultaneously warm the first side portion of the wearer and the opposite second side of the wearer upon positioning the wearable covering in a passageway in an energizable coil.

In the various embodiments, the wearable covering may be gloves, mittens, shoes, boots, and other wearable coverings.

### BRIEF DESCRIPTION OF THE DRAWINGS

The subject matter which is regarded as the disclosure is particularly pointed out and distinctly claimed in the concluding portion of the specification. The disclosure, however, may best be understood by reference to the following detailed description of various embodiments and the accompanying drawings in which:

FIG. 1 is a front, right perspective view from above of a wearable covering such as a pair of gloves and a warming or induction heating station, according to an embodiment of the present disclosure;

FIG. 2 is a front, left perspective view from above, partially cut away, of the induction heating station of FIG. 1, according to an embodiment of the present disclosure;

FIG. 3 is a rear, left perspective view, partially cut away, of the induction heating station of FIG. 1, according to an embodiment of the present disclosure;

FIG. 4 is a front, left perspective view from below, partially cut away, of the induction heating station of FIG. 1, according to an embodiment of the present disclosure;

FIG. 5 is a diagrammatic illustration of the induction coils of the induction heating station of FIG. 1, according to an embodiment of the present disclosure;

FIG. 6 is a block diagram of the induction heating station of FIG. 1, according to an embodiment of the present disclosure;

FIG. 7 is a block diagram of an induction heating station, according to an embodiment of the present disclosure;

FIGS. 8 and 9 are perspective views of the right hand glove of FIG. 1, according to an embodiment of the present disclosure;

FIG. 10 is a cross-sectional view of a portion of a glove having a fabric layer and a conductive material layer, according to an embodiment of the present disclosure;

FIG. 11 is a cross-sectional view of a portion of a glove having fabric layers and a conductive material layer, according to an embodiment of the present disclosure;

FIG. 12 is a diagrammatic illustration of the right hand glove undergoing induction heating in the induction heating station of FIG. 1, according to an embodiment of the present disclosure;

FIG. 13 are side elevational views of a wearable covering having a liner and glove receivable on a hand of a user, according to an embodiment of the present disclosure;

FIG. 14 is a side elevational view of a wearable covering such as a ski boot and a warming or induction heating station, according to an embodiment of the present disclosure;

FIG. 15 is a side elevational view of a wearable covering in the form of a pair or liners or socks, according to an embodiment of the present disclosure;

FIG. 16 is a perspective view of a backpack having a warming or induction heating station, according to an embodiment of the present disclosure;

FIG. 17 is a perspective view of a backpack having a warming or induction heating station, according to an embodiment of the present disclosure;

FIG. 18 is a perspective view of a backpack having a warming or induction heating station, according to an embodiment of the present disclosure;

FIG. 19 is a flowchart of a method, according to an embodiment of the present disclosure; and

FIG. 20 is a flowchart of a method, according to an embodiment of the present disclosure.

### DETAILED DESCRIPTION

In some embodiments, the present disclosure is directed to self-contained or externally powered induction heating systems and methods tailored to outerwear, for example, gloves that can be carried by or attached to a user. The present disclosure uses induction heating principles to create an electromagnetic field or forces which, in turn, cause warming of conductive material within or attached to the outerwear inserted into the electromagnetic field. The system may use less energy than conventional systems that are currently available on the market.

The present disclosure may allow for gloves that includes a conductive material to benefit from the principles of the present disclosure without the necessity of integrated wires or power sources within the glove. Industry trends in fabric and textile design include thermal reflective technologies that use metals in their design. Apparel or garments that includes metallic and/or conductive materials that can be operably inserted or connected to induction heating systems may benefit from the induction heating principles to create warmth.

The present disclosure may include induction heating systems having points of connection to external coils that will in turn create an electromagnetic field and warming effect. An example may be ski boots that have coils or connection points built into their design that will be energized when connected in connection with the techniques of the present disclosure.

As will be appreciated, the present disclosure may provide a user with the ability to insert physical appendages or extremities that are covered by induction capable materials that partially or fully wrap around in the form of gloves, socks, liners or other items or shapes to increase the temperature environment within the garment to allow the user to prevent numbness, frostbite or general loss of dexterity. The user may freely choose various parts of the body to receive the benefits of the induction heated field and limit the effect to areas not in need of its benefits thereby assuring the expended energy or battery life is used in its most efficient manner. The present disclosure employing the nature of induction heat, may instantly create the ability for the user to benefit from its heating abilities once turned on reducing the warm up time compared to conventional resistance heating elements such as in heating pads in which the resistance elements are directly connected to a power supply.

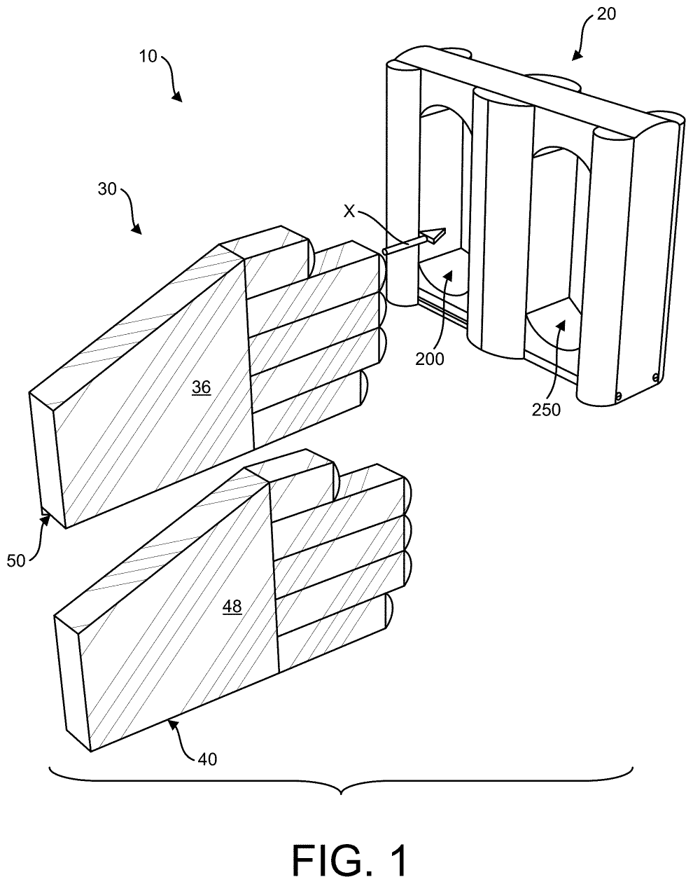

FIG. 1 illustrates a system 10 operable to provide an extremity outerwear induction heating system, according to the embodiment of the present disclosure. For example, system 10 may generally include an electromagnetic or induction heating station 20 and at least one wearable covering 30. In this illustrated embodiment, wearable covering 30 may include a pair of gloves, e.g., a right hand glove 40 and a left hand glove 50. As shown in FIG. 1, left hand glove 50 may be inserted into the left side of induction heating station 20. For example, a wearer may hold induction heating station 20 with the right hand, and insert their left hand wearing the left hand glove into the left side of induction heating station 20. Once the right hand and/or right hand glove are warmed, the wearer can removed the left hand and glove from the induction heating station 20, and hold induction heating station 20 with their left hand and insert the right hand and right hand glove into the right side of induction heating station 20.

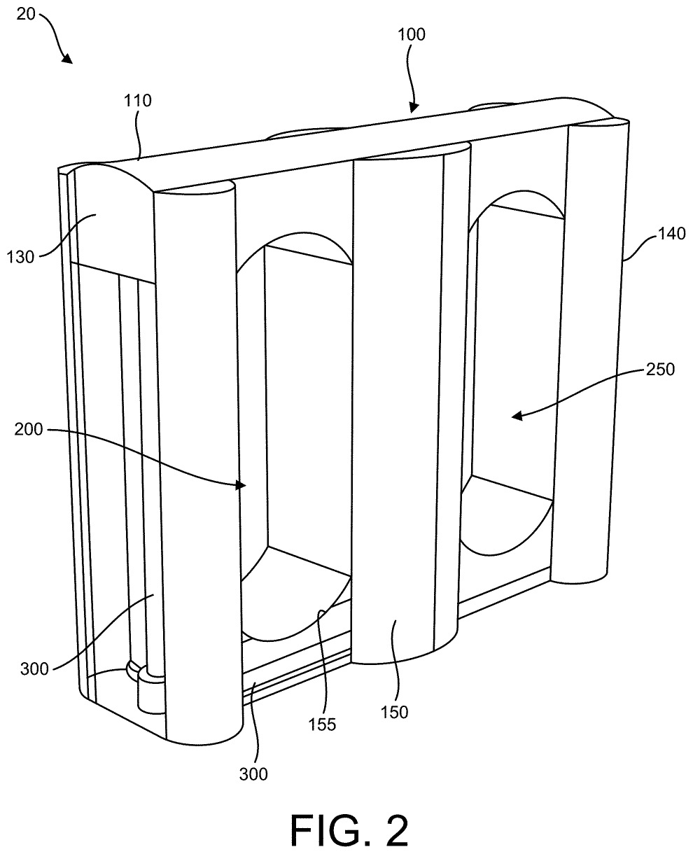

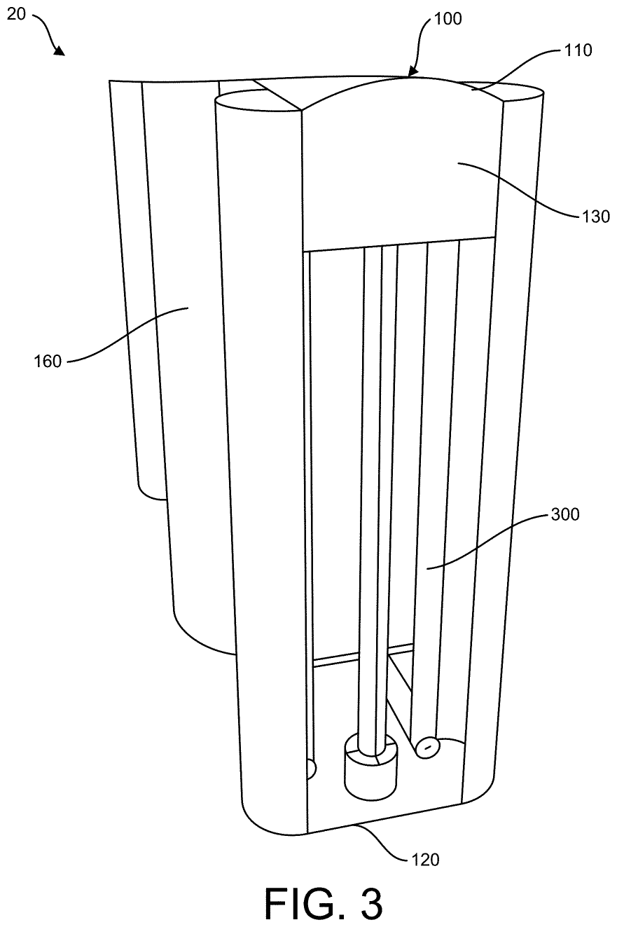

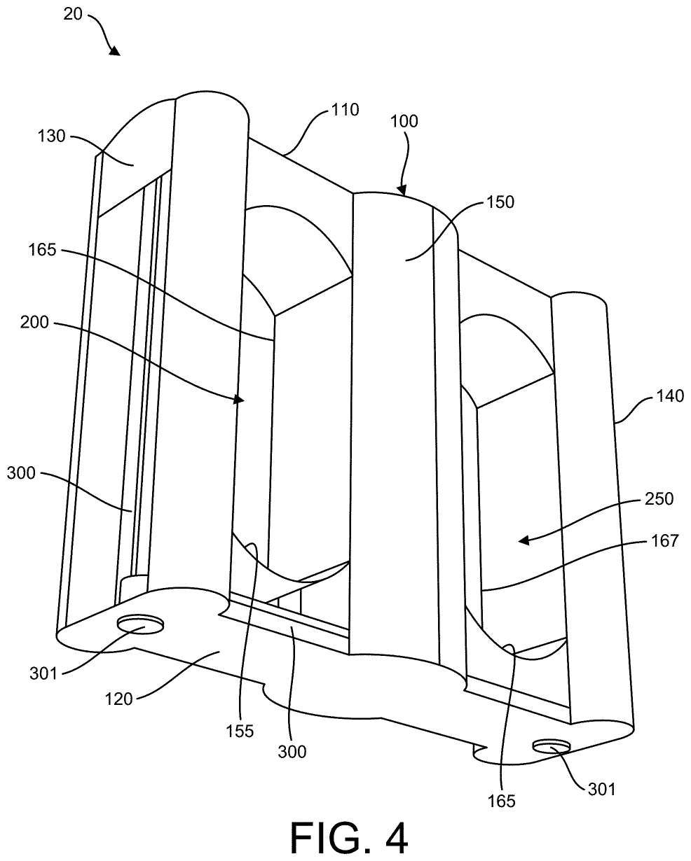

As shown in FIGS. 2-4, induction heating station 20 may include a housing 100 having a top side 110, a bottom side 120 (FIG. 4), a left side 130, a right side 140, a front side 150, and a rear side 160 (FIG. 3). Housing 10 includes at least one passageway, and may include a plurality or pair of passageways 200 and 250, such as parallel passageways, according to an embodiment of the present disclosure.

For example, passageway 200 may extend from front side 150 to rear side 160 (FIG. 3). Passageway 200 may open onto front side 150 defining an opening 155, and open onto rear side 160 defining an opening 165 (FIG. 4). Passageway 250 may extend from front side 150 to rear side 160 (FIG. 3). Passageway 250 may open onto front side 130 defining an opening 165, and open onto rear side 140 defining an opening 167 (FIG. 4). Passageway 200 may be an elongated passageway or oblong passageway having spaced apart parallel inner sides and curved and lower inner sides. Passageway 250 may be an elongated passageway or oblong passageway having spaced apart parallel inner sides and curved upper and lower inner sides.

Induction heating station 20 may include housing 100 having at least one passageway and at least one induction coil or energizable coil, according to an embodiment of the present disclosure. In this illustrated embodiment, induction heating station 20 includes pair of passageways 200 and 250, and a pair of induction coils or energizable coils. For example, induction heating station 20 may include a pair of induction coils or energizable coils, one of which, e.g., energizable coil 300, being shown in FIGS. 2-4.

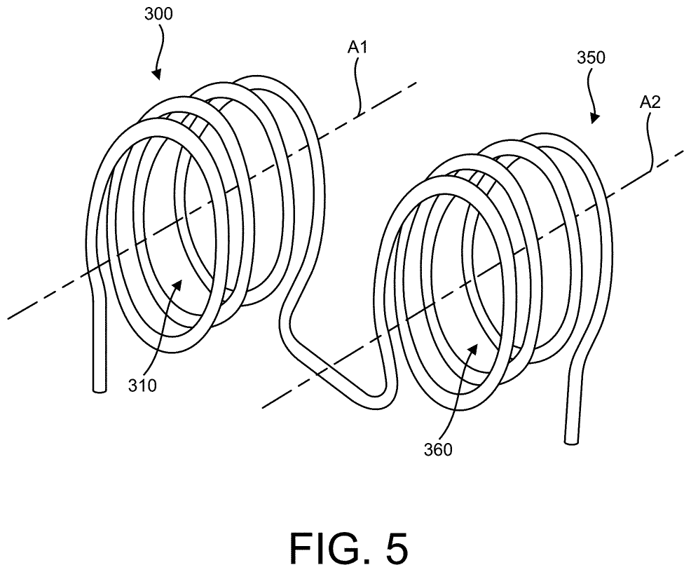

FIG. 5 diagrammatically illustrates induction coil 300 having a plurality of windings surrounding a passageway 310, and an induction coil 350 having a plurality of windings surrounding a passageway 360. Passageways 310 and 360 may be elongated passageways or oblong passageways, for example, sized larger than the passageways in induction heating station 20 (FIG. 1). An axis A1 of passageway 300 and an axis A2 of passageway 360 may be parallel and spaced from each other. Induction coil 300 may be electrically connected to induction coil 350 and operably connectable to an electrical power source. For example, induction coil 300 may be sized larger than and extend around passageway 200 (FIG. 2) in housing 100 (FIG. 2). Induction coil 350 may be sized larger than and extend around passageway 250 (FIG. 2) in housing 100 (FIG. 2). In other embodiments, the one or more induction coils may be stand-alone induction coils and separately connectable to one or more electrical power sources.

With reference again to FIG. 1, induction heating station 20 may be a portable induction heating station, for example, attachable to outer clothing of a wearer such as attachable to a jacket or pants, e.g., ski jacket or ski pants. In addition to the user being able to use induction heating station 20 to heat or warm their own wearable coverings 30, induction heating station 20 may allow the user to share or loan induction heating station 20 with others having such wearable coverings and provide such warming benefits to others.

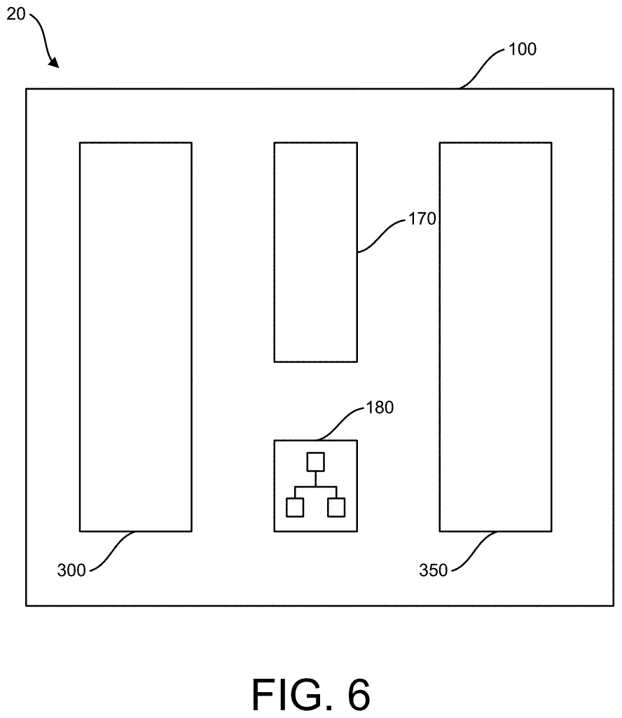

As diagrammatically shown in FIG. 6, induction heating station 20 may include housing 100, induction coil 300, induction coil 350, a power source 170, and a controller 180. Power source 170 may be a battery or other rechargeable material disposed in induction heating station 20, for example, in the center of the housing in the space between the passageways of induction heating station 20. Controller 180 may include a switch for turning on and off the power supply to the induction coils, and circuitry for controlling the power supply to the induction coils to affect the induction heating of the wearable covering as described below. In other embodiments, the controller 180 may include a logic chip, a microcontroller, or a processor, memory operably connected to the processor, and one or more input/output devices.

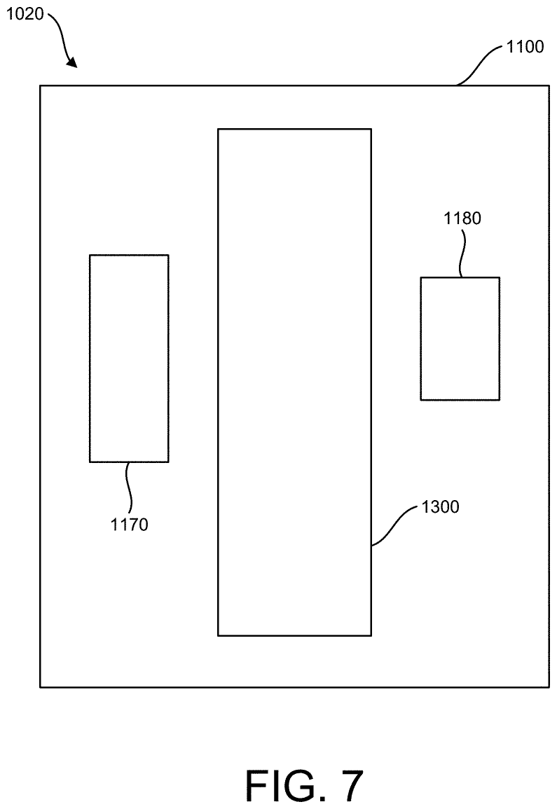

In other embodiments, for example, as shown in FIG. 4, induction heating station 20 may include contacts 301 and 302 that operably connect to the ends of the wire forming the windings of the induction coils. Contacts 301 and 302 may be operably connected to a power source such as an external power source. As diagrammatically shown in FIG. 7, in other embodiments, an induction heating station 1020 may include a housing 1100 having a single passageway, a single induction coil 1300 having a passageway surrounding the single passageway of housing 1100, a power source 1170, and a controller 1180. In some embodiments, the housings may include one or more sensors for determining when the wearable covering is received in the passageway in the induction heating station and/or monitoring the temperature of the wearable covering when undergoing induction heating. The sensors may be connected to the controller having operable logic or programming to control the induction heating station, for example, for turning on, monitoring and controlling the heating, and/or turning off the induction heating station.

With reference again to FIG. 1, passageways 200 and 250 may be sized to receive wearable covering 30 therein such as right hand glove 40 and left hand glove 50. The wearable covering is sized and configured to extend around a portion such as an extremity of a wearer and fit within the passageways in housing 100. For example, right hand glove 40 may extend around a right hand of a wearer and left hand glove 50 may extend around the left hand of the wearer. The wearable covering includes conductive materials, for example, metals or semi-conductors, as described further below.

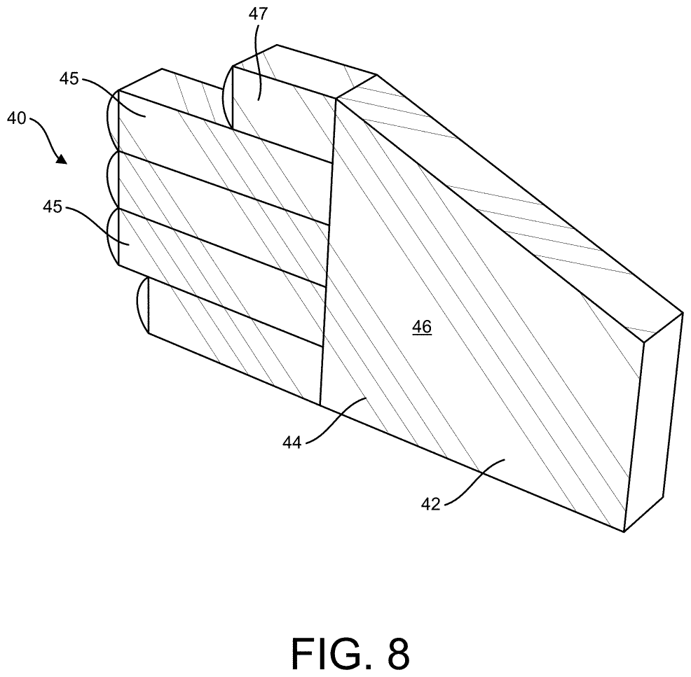

For example, as shown in FIGS. 8 and 9, right hand glove 40 may include one or more layers or webs of material or fabric 42 and conductive material 44 that surrounds the hand of a wearer such as extends along a front side 46 (FIG. 8) of glove 40 and a front side of the hand of the wearer, and an opposite or a back side 48 (FIG. 9) of glove 40 and a back side of the hand of the wearer. Glove 40 may include fingers 45 and a thumb 47 for individually surrounding the fingers and thumb of the hand of the wearer. In some embodiments, the conductive material of the gloves may extend around the front, back, and sides of the fingers and the thumb, and along the tips of the fingers and thumb. In other embodiments, the conductive material may extend around the entire wearable covering.

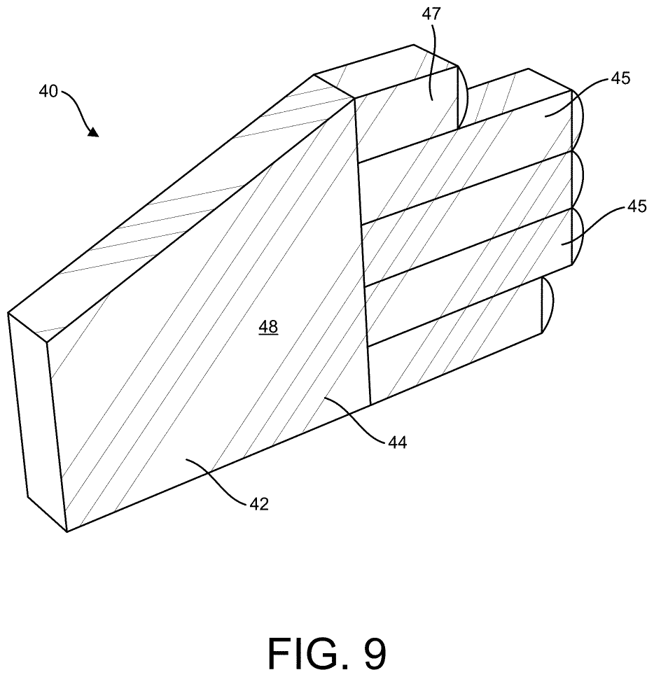

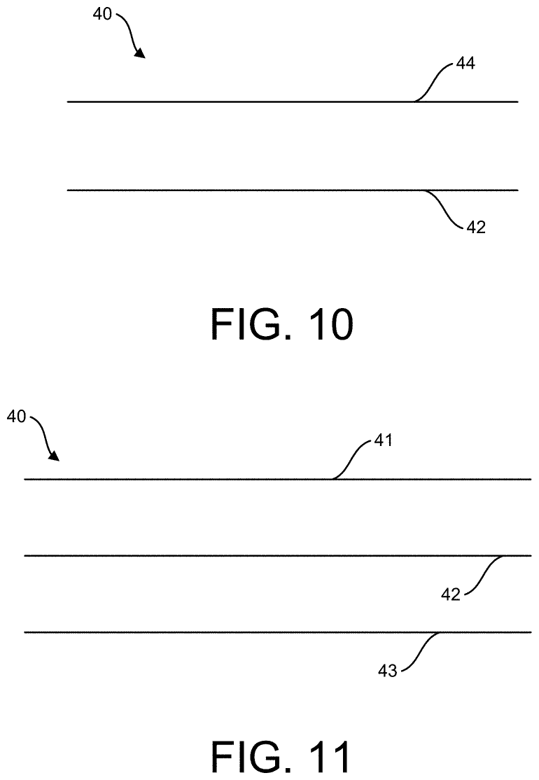

The wearable covering or right hand glove 40 may include conductive material or metal 44 in or on the one or more layers or webs of material or fabric 42. The conductive material or metal 46 may be dispersed throughout the wearable covering or glove 40 or disposed in spaced apart conductive or metal wires. For example, as shown in FIG. 10, a cross-sectional view of the thickness of the glove 40 may include wires, strips or a layer of metal or conductive material 44 disposed along the outside of glove 40 and outside one or more layers or webs of material or fabric 42. As shown in FIG. 11, a cross-sectional view of the thickness of glove 40 may include one or more layers or webs of outer insulating material or fabric 41, and one or more layers or webs of inner material or fabric 43. Wires, strips or a layer of metal or conductive material 44 may be disposed and sandwiched between the outer insulating material or fabric 41 and the inner material or fabric 43. Left hand glove 50 (FIG. 1) may be essentially the same as right hand glove 40. It will be appreciated that the wearable covering may have other suitable configurations.

With reference again to FIG. 1, the wearable covering 30 such as gloves 40 and 50 may be insertable and removable in the respective passageways 200 and 250 of induction heating station 100. For example, right hand glove 40 may be insertable and removable in station 200 in induction heating system 20 to simultaneously warm a first or front side 46 (FIG. 8) of right hand glove 40 and the front side of the right hand of the wearer, and the opposite second or back side 48 of right hand glove 40 and the back side of the right hand of the wearer in response to induction heating between the wearable covering in the passageway 200 in energized coils 300. Left hand glove 50 may be insertable and removable in passageway 250 in induction heating system 20 to warm a first or front side 36 of left hand glove 50 and the rear side of the left hand of the wearer, and the opposite second or back side (not shown in FIG. 1) of left hand glove 50 and the back side of the left hand of the wearer in response to induction heating of the wearable covering in the passageway 250 in energized coils 350. In some embodiments, the gloves 40 and 50 may include fingers and thumbs having a conductive material disposed on a first side and disposed on an opposite second side of the fingers and thumbs of the gloves. For example, the tops of the fingers and/or thumbs, the bottoms of the fingers and/or thumbs, and/or the lateral sides of the fingers and/or thumbs may include conductive material and may be warmed by passing into the passageways of the induction heating station 20.

For example, a wearer may hold induction heating station 20 with the right hand, and insert the left hand wearing the left hand glove into the left side of induction heating station 20. Once the right hand and/or right hand glove are warmed, the wearer can removed the right hand and glove from the induction heating station 20, and hold induction heating station 20 with the left hand and insert the right hand and right hand glove into the right side of induction heating station 20. In other embodiments, the right hand glove 40 may be inserted in a first direction (for example, in the direction of arrow X as shown in FIG. 1) and maintained in passageway 250 during the induction heating, and the left hand glove 50 may be simultaneously inserted in a second direction opposite the first direction (for example, from the back side of induction heating station 100) and maintained in passageway 350 during the induction heating.

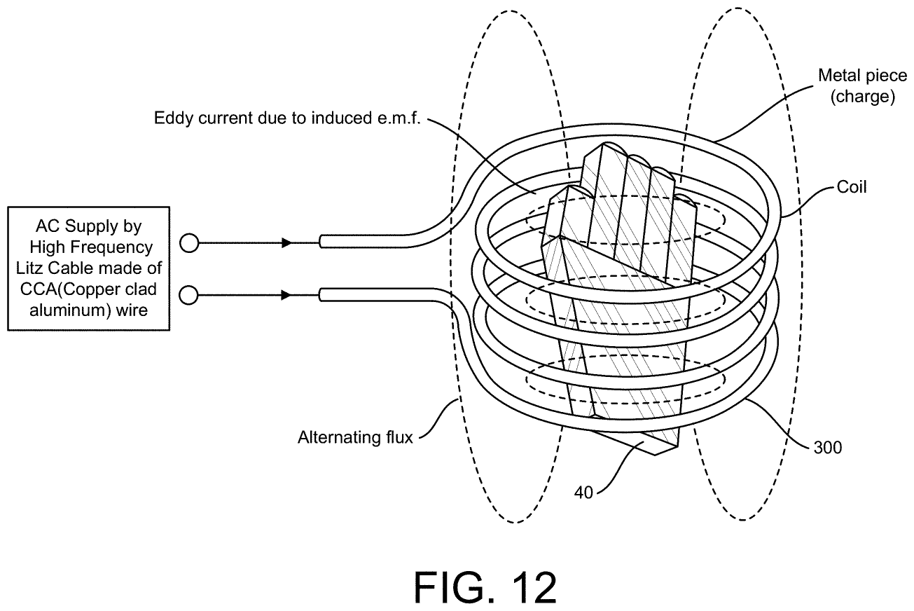

When energized, the coils around the openings in the housing create an electromagnetic field or forces. Induction heating is a non-contact heating process which utilizes the principle of electromagnetic induction to produce heat inside a metal or electrically conductive material. By placing a conductive material into an alternating magnetic field, electrical current can be made to flow in the material thereby creating heat due to the I2R losses in the conductive material. In magnetic materials, further heat is generated below the Curie point due to hysteresis losses. For example, as shown in FIG. 12, alternating current may be supplied by a cable such as a high frequency Litz cable made of copper clad aluminum to the windings of induction coil 300. The alternating current in the windings in induction coil 300 generate an alternating flux, that in turn, generates eddy currents in the metal or conductive material in the wearable covering or glove 40 to thereby heat the wearable covering or glove.

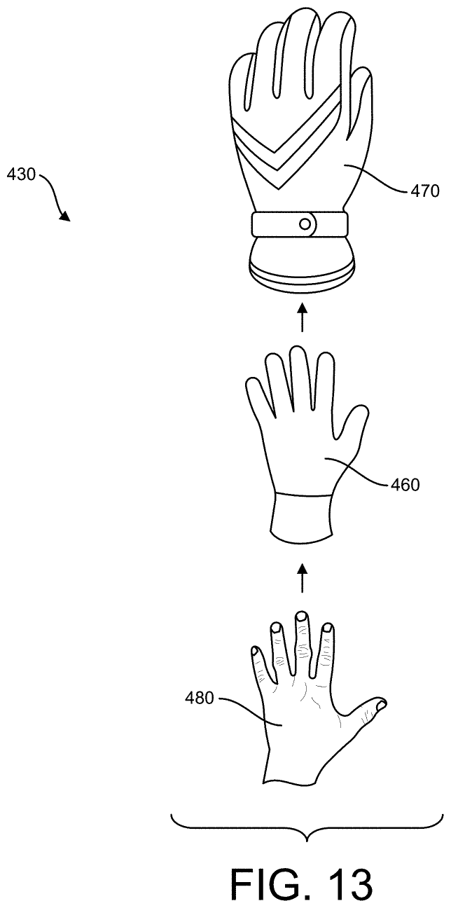

FIG. 13 illustrates a wearable covering 430 in the form of a liner 460 that fits with in a glove 470, according to an embodiment of the present disclosure. For example, a wearer would insert their hand 480 into to liner 460, which hand and liner may then be inserted in glove 470. In this embodiment, liner 460 may include conductive material thereby allowing the liner to be heated and warmed by an induction heating station such as described herein. For example, liner 460 may include conductive material on a front hand side of the liner, on back hand side of the liner, and/or on the front, back, and lateral sides of the fingers and thumbs. In some embodiments, the conductive material may extend over the entire liner. In some embodiments, liner 460 may employ metallic printing on the outside of the liner, inside of the liner, or may be disposed between the inside and outside of the liner having an outer layer and/or an inner layer such as fabric or insulating layers. Wearable covering 430 and a glove or mitten may be heated or warmed using the induction heating stations described herein.

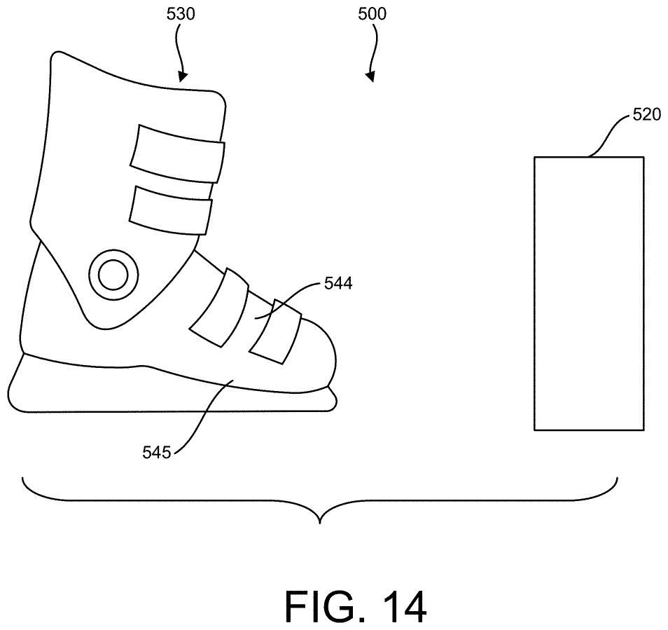

FIG. 14 illustrates a system 500 operable to provide an extremity outerwear induction heating system, according to the embodiment of the present disclosure. For example, system 500 may generally include an induction heating station 520 and at least one wearable covering such as a pair or ski boots 530, one of which is shown in FIG. 14. In this illustrated embodiment, ski boot 530 may include conductive material 544 disposed along the top of ski boot 530 and above a foot of a wearer, and conductive material 545 disposed along the bottom of ski boot 530 and below the foot of the wearer. Right foot ski boot 530 and a left foot ski boot (not shown) may be alternately inserted into a passageway in induction heating station 450 to simultaneously warm the top and bottom of the ski boot 530 and foot of the wearer as described above in connection with wearable covering 30 (FIG. 1) and inductive heating station 20 (FIG. 1). In other embodiments, the conductive material may extend around the entire foot or feet of the wearer.

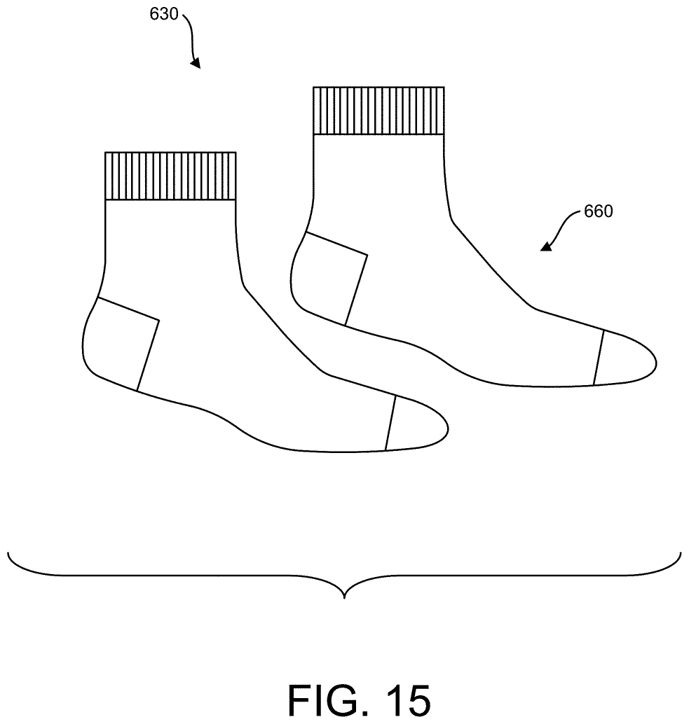

FIG. 15 illustrates a wearable covering 630 in the form of a pair of liners or socks 660 that fit with in shoes or boots, according to an embodiment of the present disclosure. For example, a wearer would insert their feet into to liners 660, which feet and liners may then be inserted in a pair of shoes or boots. In this embodiment, liners 660 may include conductive material thereby allowing the liner to be heated and warmed by an induction heating station such as described herein. For example, liners 660 may include conductive material on a top side of the liner, on a bottom side of the liner, and/or on the lateral sides of the liners. In some embodiments, the conductive material may extend over the entire liner. In some embodiments, liners 660 may employ metallic printing on the outside of the liner, inside of the liner, or may be disposed between the inside and outside of the liner having an outer layer and/or an inner layer such as fabric or insulating layers. Wearable covering 630 and a shoe or boot may be heated or warmed using the induction heating stations described herein.

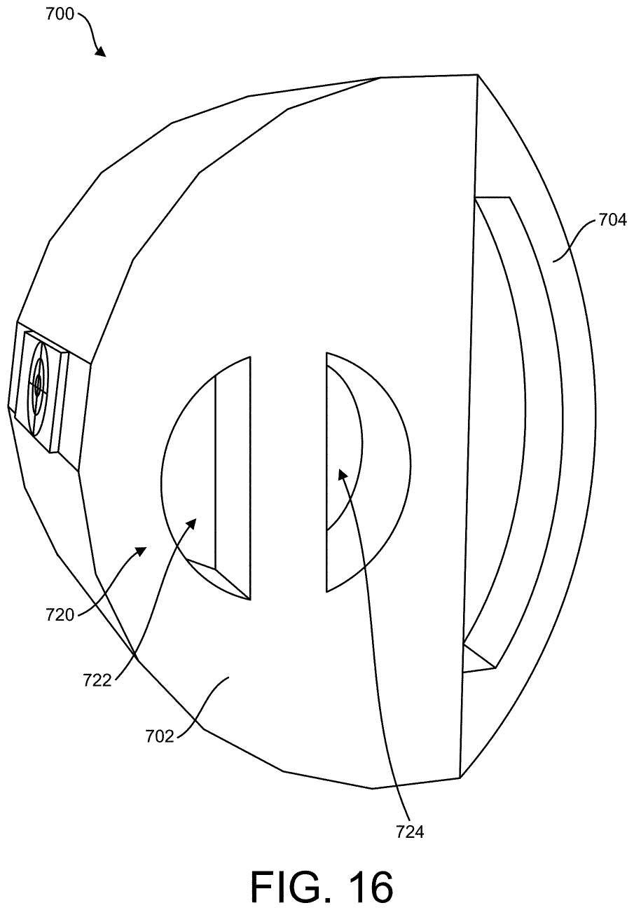

FIG. 16 illustrates a backpack 700 having an outer shell or body 702 and a pair of shoulder straps 704, one of which is shown, according to an embodiment of the present disclosure. In this illustrated embodiment, backpack 700 may include an electromagnetic or induction heating station 720 incorporated therein. For example, backpack 700 may include a first passageway 722 and second passageway 724, which passageway are surrounded by induction coils allowing a user to insert and warm or heat one or more wearable coverings, for example, gloves, shoes or boots. The passageways may open and extend from one side of the backpack to the other side of the back pack, or may only open and extend along a portion of the backpack. Induction heating station 720 may be similarly configured as the induction heating stations described herein.

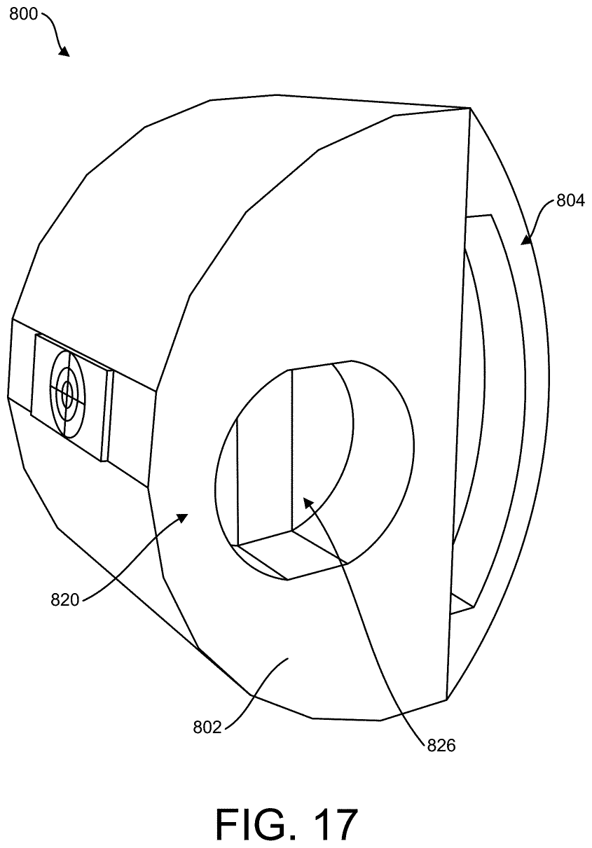

FIG. 17 illustrates a backpack 800 having an outer shell or body 802 and a pair of shoulder straps 804, one of which is shown, according to an embodiment of the present disclosure. In this illustrated embodiment, backpack 800 may include an electromagnetic or induction heating station 820 incorporated therein. For example, backpack 800 may include a single passageway 826, which passageway is surrounded by an induction coil allowing a user to insert and warm or heat one or more wearable coverings, for example, gloves, shoes or boots. The passageway may open and extend from one side of the backpack to the other side of the back pack, or may only open and extend along a portion of the backpack. Induction heating station 820 may be similarly configured as the induction heating stations described herein.

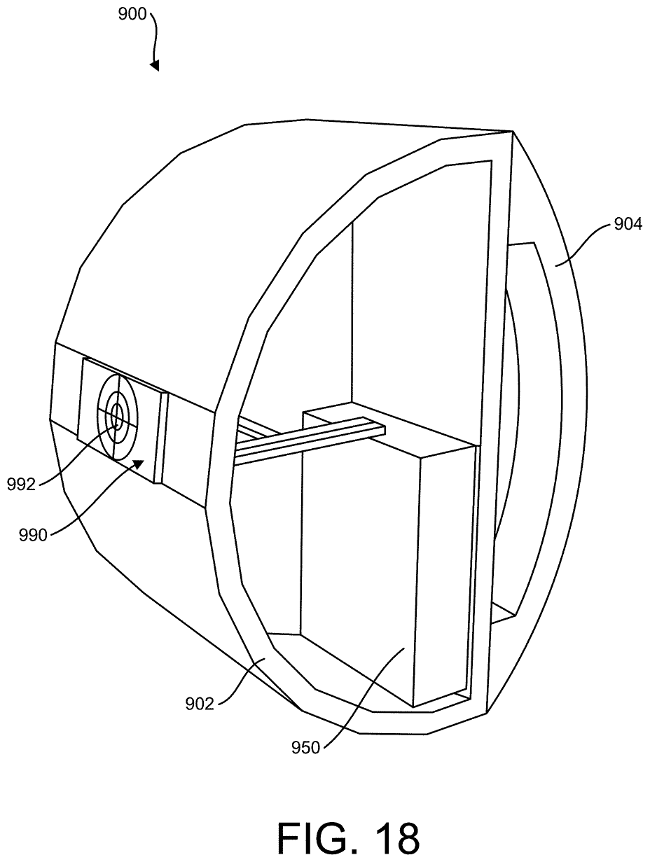

FIG. 18 illustrates a backpack 900 having an outer shell or body 902 and a pair of shoulder straps 904, one of which is shown, according to an embodiment of the present disclosure. In this illustrated embodiment, backpack 900 may include an electromagnetic or induction heating station 990 incorporated therein. For example, induction heating station 990 may include and electromagnetic or induction surface 992 integrated into backpack 900 that is connected to the power source 950 through wires that when touched and connected will heat the conductive materials within the electromagnetic field. Induction surface 992 may be a 6 inch by 6 inch touch point on backpack 990 that, when activated, will allow the user to merely touch the area with their gloves or boots to warm them. In this illustrated embodiment, the induction heating station 990 may have an induction coil disposed parallel with and under surface 992.

In other embodiments, an electromagnetic or induction heating station may be integrated into a piece of outerwear or accessory, e.g., coat, jacket, handbag, pocketbook, purse, pants, etc.

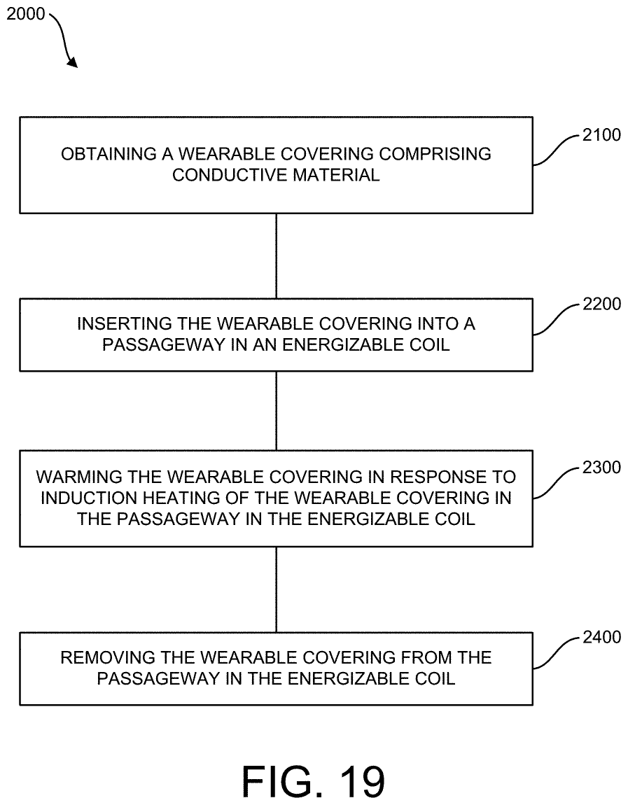

FIG. 19 illustrates one example of a method 2000 for heating a wearable covering, according to an embodiment of the present disclosure. For example, method 1000 may include at 2010 obtaining a wearable covering comprising metal, at 2020 inserting the wearable covering into a passageway in an energizable coil, at 2030 warming the wearable covering in response to induction heating of the wearable covering in the passageway in the energizable coil, and 2040 removing the wearable covering from the passageway in the energizable coil. The user may wear the wearable covering while inserting and removing the wearable covering in the energizable coil, or need not wear the wearable covering when inserting and removing the wearable covering in the energizable coil.

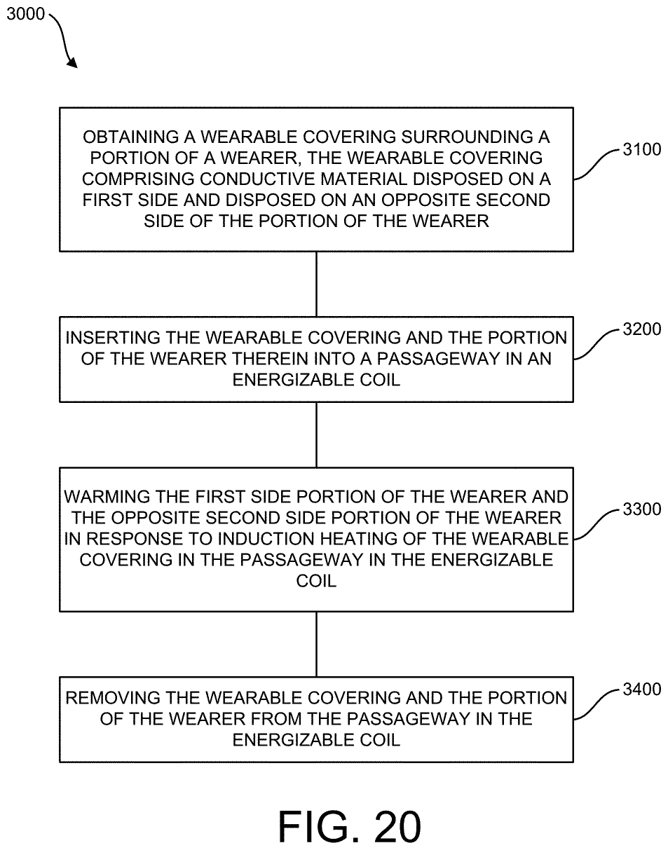

FIG. 20 illustrates one example of a method 3000 for heating a wearable covering, according to an embodiment of the present disclosure. For example, method 3000 may include at 3100 obtaining a wearable covering surrounding a portion or extremity of a wearer, the wearable covering comprising metal disposed on a first side and disposed on an opposite second side of the portion or extremity of the wearer, at 3200 inserting the wearable covering and the portion of the wearer therein into a passageway in an energizable coil, at 3300 warming the first side of the portion of the wearer and the opposite second side of the portion of the wearer in response to induction heating of the wearable covering in the passageway in the energizable coil, and at 3400 removing the wearable covering and the portion of the wearer from the passageway in the energizable coil.

In some embodiments, the induction heating station may be portable and carried by a wearer for use by the wearer and others. In other embodiments, one or more induction heating stations may be disposed in fixed locations, such as locations on a ski resort and may include chair lifts, cable cars, ski slopes, ski lodges, and other locations. As will be appreciated by the present disclosure, in some embodiments, the wearable coverings or garments do not require electrical infrastructure built into the wearable coverings or garments. The technique of the present disclosure may provide a field that the user can either place the conductive materials (garments) against or within the electromagnetic field to enact the induction heating process. For example, the wearable coverings having conductive material disposed on opposite sides or surfaces of the wearer that may be placed in a passageway in the inductive coil or placed adjacent to a passageway in the inductive coil to heat opposite sides of the wearable covering and opposite sides or surfaces of, e.g., an extremity of the wearer.

In other embodiments, the wearable induction heating technology of the present disclosure may be utilized in connection with fabrics for military and outdoor sports applications. The technique of the present disclosure may be advantageous and beneficial to the outerwear of hunters, soldiers, athletes, and others that spend time outdoors in cold weather theaters or environments.

In the various embodiments, the induction heating may provide a fast and highly efficient means of heating various types of wearable covering having electrically conductive metals and conductive materials, which metals and conductive materials may include, alone or in combination, copper and copper alloys, brass, aluminum, iron, steel and stainless steel, tungsten, chrome, nickel and nickel alloys, cobalt, carbon fiber, graphite, silicon, platinum, silver, gold, other metals and semiconductors, and any other materials that may be heated by induction heating. The metals and conductive materials may be disposed in the wearable covering in layers, dispersed throughout a layer, woven or spaced apart wires, applied via a dot matrix process. In some embodiments, the metallic or conductive material may be disposed along the inside of the wearable covering and may also be operable to reflect body heat back to the extremity of the wearer.

The structure and configuration of the components of the induction heating stations, e.g., material or materials, number and diameter of the wires forming the induction coils, voltage and amperage of the supplied electrical power, and the wearable coverings, e.g., thickness and amount of the conductive materials, may be optimized. For example, the structure and configuration of the components of the induction heating stations and wearable coverings may be selected to optimize or reduce the requirement for a power supply such as a battery. The size and configuration of the induction heating stations and wearable coverings may also take into account the heating depth required. The induction heating stations may be powered by a power source or battery operable at 1.5 volts, 3 volts, 4.5 volts, 5 volts, 6 volts, 9 volts, 12 volts, 60 volts, 120 volts, between 1 volt and 12 volts, between 1 volt and 6 volts, between 1 volt and 3 volts, or other suitable voltage. The induction heating stations may include an operable inverter to convert (DC) voltage to (AC) voltage. For example, an inverter is an electronic device that changes direct current to alternating current. The inverter takes energy stored in a DC battery or other energy source, and may use pulse-width modulation (PWM) to generate AC output voltage and current. In other embodiment, a zero voltage switching (ZVS) driver may be employed.

The coils in the induction heating stations may include a single winding or loop, 2 windings, 3 windings, 4 windings, 5 windings, 6 windings, 7 windings, 8 windings, 9 windings, 10 windings, 20 windings, 30 windings, 50 windings, 100 windings, between 1 and 5 windings, between 3 and 7 windings, between 1 and 10 windings, less than 10 windings, less than 20 windings, greater than 10 windings, greater than 20 windings, or other suitable number of windings. In the various embodiments, the induction heating stations may have two separate spaced apart coils or more that may be serially connected or connected in parallel. The coils may have an oval, oblong, or rectangular shape, or other suitable shapes operable to create an induction heated field.

The induction heating stations may by the nature of induction heat, turn off instantly and doesn't remain hot beyond what the user needs or desires. For example, induction heating stations may have an on/off switch for turning on and off, and may include an automatic shutoff or safety feature that turns off after a predetermined time, for example, 2 seconds, 3 seconds, 5 second, 10 second, 15 seconds, 20 second, 30 seconds, between 2 seconds and 1 minute, between 5 seconds and 30 sections, between 5 seconds and 15 seconds, less than 15 seconds, less than 10 seconds, less than 5 seconds, or other suitable predetermined time period.

In some embodiments, the induction heating stations may include a built-in rechargeable battery that provides for a plurality of heating cycles per charge. For example, the induction heating stations may include a battery or rechargeable battery rated at 200 mAh (milliamp Hour), 400 mAh, 600 mAh, 800 mAh, 1000 mAh, 1200 mAh, 1400 mAh, 1600 mAh, 1800 mAh, 2000 mAh, 2500 mAh, 3000 mAh, 4000 mAh, 5000 mAh, between 200 and 500 mAh, between 500 and 1000 mAh, between 500 and 2000 mAh, less than 5000 mAh, less than 1500 mAh, or other suitable energy capacity battery or rechargeable battery. In some embodiments, two or more such batteries or rechargeable battery may be employed.

Induction heating may be less consuming of energy and has the ability to turn on/off in an instant and provided a benefit over resistance heating that requires more energy and a matrix of wires built into the wearable covering or garment to provide warmth.

While in some embodiments the wearable covering is shown as gloves having individual fingers, the technique of the present disclosure may be incorporated into wearable covering such as mittens that do not have separate individual fingers.

The induction heating technique of the present disclosure may be incorporated in any wearable coverings and may include shirts, vests, jackets, coats, parkers, tee shirts, underwear, pants, headgear, hats, helmets, ear muffs, scarfs, footgear, boots, shoes, sneakers, work boots, or other items worn by a user.

In other embodiments, the induction heating technique of the present disclosure may be incorporated similar to heat packs for use as, for example, hand or foot warmers that may be held directly in the palm of the hand by user or held by a glove or mitten worn by a user. The hand warmer may have a rectangular or oval planar configuration and include a thermal absorbing and retaining material and a conductive material. The conductive material may be electromagnetically heated when disposed outside or away from a passageway an energized coil, or when disposed in a passageway in an energized coil, to heat the thermal absorbing and retaining material. The thermal absorbing and retaining material may have a high specific heat capacity, which then gradually releases the heat over time. The thermal absorbing and retaining material may be a suitable liquid, solid, beads, or other material or combination of materials.

As may be recognized by those of ordinary skill in the art based on the teachings herein, numerous changes and modifications may be made to the above-described and other embodiments of the present disclosure without departing from the scope of the disclosure. The components of the wearable coverings and induction heating station as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the home plate foundation forms may include more or fewer components or features than the embodiments as described and illustrated herein. Accordingly, this detailed description of the currently-preferred embodiments is to be taken in an illustrative, as opposed to limiting of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The disclosure has been described with reference to the preferred embodiments. It will be understood that the embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

1. A method comprising:
obtaining a wearable covering comprising conductive material;
inserting the wearable covering into a passageway in an energizable coil;
warming the wearable covering in response to induction heating of the wearable covering in the passageway in the energizable coil; and
removing the wearable covering from the passageway in the energizable coil.

2. The method of claim 1 wherein:
the wearable covering is disposable around a portion of a wearer with the conductive material disposed on a first side of the wearable covering and over a first side portion of the wearer, and the conductive material disposed on an opposite second side of the wearable covering and over a second side portion of the wearer; and
the warming comprises simultaneously warming the first side of the wearable covering and the opposite second side of the wearable covering in response to induction heating of the wearable covering in the passageway in the energizable coil.

3. The method of claim 1 wherein:
the inserting comprises inserting the wearable covering into a passageway in a housing disposed around the passageway in the energizable coil; and
the removing comprises removing the wearable covering from the first passageway in the housing.

4. The method of claim 1 wherein:
the wearable covering comprises a first wearable covering comprising the conductive material and a second wearable covering comprising the conductive material;
the inserting comprises inserting the first wearable covering into a first passageway in a housing disposed around the passageway in the energizable coil, and inserting the second wearable covering into a second passageway in the housing disposed around a second passageway in a second energizable coil; and
the removing comprises removing the first wearable covering from the first passageway in the housing, and removing the second wearable covering from the second passageway in the housing.

5. A method of claim 1 comprising:
the obtaining comprises obtaining the wearable covering comprising a glove comprising the conductive material;
the inserting comprises inserting the glove into the passageway in the energizable coil;
the warming comprises warming the glove in response to the induction heating of the glove in the passageway in the energizable coil; and
the removing comprises removing the glove from the passageway in the energizable coil.

6. The method of claim 1 wherein:
the obtaining comprises obtaining the wearable covering comprising a glove comprising the conductive material disposed along a front of the glove and the conductive material disposed along a back of the glove;
the inserting comprises inserting the glove into the passageway in the energizable coil;
the warming comprises simultaneously warming the front of the glove and the back of the glove in response to the induction heating of the glove in the passageway in the energizable coil; and
the removing comprises removing the glove from the passageway in the energizable coil.

7. The method of claim 6 wherein:
the glove comprises fingers, and the fingers comprises conductive material disposed on a first side of the fingers and conductive material disposed on an opposite second side of the fingers of the glove; and
the warming comprises simultaneously warming the first side and the second side of the fingers in response to the induction heating of the glove in the passageway in the energizable coil.

8. The method of claim 1 further comprising:
the obtaining comprises obtaining the wearable covering comprising a right hand glove comprising the conductive material and a left hand glove comprising the conductive material;
the inserting comprises inserting the right hand glove into a first passageway in a housing disposed around the passageway in the energizable coil, and inserting the left hand glove into a second passageway in the housing disposed around a second passageway in a second energizable coil; and
the removing comprises removing the right hand glove from the first passageway in the housing, and removing the left hand glove from the second passageway in the housing.

9. The method of claim 1 wherein:
the obtaining comprises obtaining the wearable covering comprising a shoe or boot;
the inserting comprises inserting the shoe or boot into the passageway in the energizable coil;
the warming comprises warming the shoe or boot in response to the induction heating of the shoe or boot in the passageway in the energizable coil; and
removing comprises removing the shoe or boot from the passageway in the energizable coil.

10. The method of claim 1 wherein:
the obtaining comprises obtaining the wearable covering comprising a shoe or boot comprising the conductive material disposed along a top of the shoe or boot and the conductive material disposed along a bottom of the shoe or boot;
the inserting comprises inserting the shoe or boot into the passageway in the energizable coil;
the warming comprises simultaneously warming the top of the shoe or boot and the bottom of the shoe or boot in response to the induction heating between the glove in the passageway in the energizable coil; and
removing comprises removing the shoe or boot from the passageway in the energizable coil.

11. The method of claim 1 wherein:
the obtaining comprises obtaining the wearable covering comprising a liner disposable on an extremity of the wearer and receivable in a glove, shoe, or boot, the liner comprising the conductive material disposed along a first side of the liner and the extremity of the wearer and the conductive material disposed along a second side of the liner and the extremity of the wearer;
the inserting comprises inserting the liner and glove, shoe, or boot into the passageway in the energizable coil;
the warming comprises simultaneously warming the first side of the liner and the second side of the liner in response to the induction heating of the liner in the passageway in the energizable coil; and
removing comprises removing the liner and glove, shoe, or boot from the passageway in the energizable coil.

12. The method of claim 1 wherein:
the inserting comprises inserting the wearable covering into the passageway disposed in a backpack;
the warming comprises warming the wearable covering in response to induction heating of the wearable covering in the passageway in the backpack; and
removing the wearable covering from the passageway in the backpack.

13. A system comprising
an induction heating station comprising a housing having at least one opening having a passageway therethrough aligned with a passageway in an energizable coil;
a wearable covering sized and configured to extend around a portion of a wearer and fit within the at least one opening in the housing, the wearable covering comprising conductive material disposed on a first side of the wearer and conductive material disposed on an opposite second side of the wearer; and
wherein the wearable covering is positionable in the at least one opening in the housing to simultaneously warm the first side of the wearer and the opposite second side of the wearer based on induction heating of the wearable covering in the passageway in the energizable coil.

14. The system of claim 13 wherein:
the wearable covering comprises a right hand glove and a left hand glove; and
the at least one opening in the housing comprises an elongated opening.

15. The system of claim 13 wherein:
the wearable covering comprises a right hand glove and a left hand glove; and
the housing comprises a first passageway therethrough aligned with the passageway in the energizable coil, and a second passageway therethrough aligned with a second passageway in a second energizable coil.

16. The system of claim 15 wherein:
the first opening in the housing comprises a first elongated opening; and
the second opening in the housing comprises a second elongated opening spaced from the first elongated opening.

17. The system of claim 13 wherein:
the wearable covering comprises at least one glove comprising conductive material disposed on a first side of the glove and the conductive material disposed on an opposite second side of the glove.

18. The system of claim 17 wherein:
the glove comprises fingers, and the fingers comprises conductive material disposed on a first side and the conductive material disposed on an opposite second side of the fingers of the glove.

19. The system of claim 13 wherein:
the wearable covering comprises at least one shoe or boot comprising conductive material disposed on a first side of the shoe or boot and the conductive material disposed on an opposite second side of the shoe or boot.

20. The system of claim 13 wherein:
the wearable covering comprises a liner disposable on an extremity of the wearer and receivable in a glove, shoe, or boot, the liner comprising the conductive material disposed along a first side of the liner and the extremity of the wearer and the conductive material disposed along a second side of the liner and the extremity of the wearer.

21. The system of claim 131 wherein:
the housing comprises a backpack comprising the energizable coil.

22. An article of clothing operable for induction heating, the article of clothing comprising:
a wearable covering positionable on a wearer;
the wearable covering comprising conductive material extendable on at least a first side portion of the wearer and conductive material disposed on a second opposite side portion of the wearer with the portion of the wearer disposable therebetween; and
the wearable covering operable to simultaneously warm the first side portion of the wearer and the opposite second side portion of the wearer upon positioning the wearable covering in a passageway in an energizable coil.

23. The article of clothing of claim 22 wherein:
wherein the conductive material extends completely around the portion of the wearer.

24. The article of clothing of claim 22 wherein:
the wearable covering comprises a wearable covering for a hand of the wearer; and
the conductive material extends over a front side and a back side of the hand.

25. The article of clothing of claim 22 wherein:
the wearable covering comprises a glove having a plurality of fingers; and
the conductive material extends along the lateral sides of the fingers of the glove; and
wherein the glove is operable to simultaneously warm the lateral sides of the fingers of the wearer upon positioning the wearable covering in a passageway in the energizable coil.

26. The article of clothing of claim 22 wherein:
the wearable covering comprises a wearable covering for a foot of the wearer; and
the conductive material extending over a top side and a bottom side of the foot.

27. The article of clothing of claim 22 further comprising:
an induction heating station comprising an energizable coil having a passageway for receiving the wearable covering.

28. The article of clothing of claim 27 wherein:
the induction heating station comprises the housing having a passageway therethrough aligned with the passageway in the energizable coil.

29. The article of clothing of claim 22 further comprising:
a backpack comprising an induction heating station.
